(19) United States
(12) Patent Application Publication
(10) Pub. No.: US 2005/0282984 A1
(43) Pub. Date: Dec. 22, 2005

(54) Triazines

(75) Inventors: Robert John Carswell, Bebington (GB); Stephen Golding, Bebington (GB); Paul Kravchuk, Bebington (GB); David Moorfield, Bebington (GB); Zongxing Qiu, Shanghai (CN); Su De-Bao, Shanghai (CN); Jane Whittaker, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Conopco, Inc., d/b/a UNILEVER

(21) Appl. No.: 11/158,790

(22) Filed: Jun. 22, 2005

(30) Foreign Application Priority Data
Jun. 22, 2004 (GB) 0413890.5

(51) Int. Cl. C08F 18/20

(52) U.S. Cl. 526/245

(57) ABSTRACT

A water-soluble, triazine-based, non-dye, cellulose cross-linking agent that has a highly flexible linking group between at least two, mono-reactive cross-linking moieties and further hydrophilic or non-hydrophilic substituents.

### TECHNICAL FIELD

The present invention relates to triazines suitable for use in fabric treatment compositions, and in particular in compositions, which can cross-link cellulose.

### BACKGROUND OF THE INVENTION

Cellulose is a beta 1-4 linked polysaccharide and the principal component of cotton, which is a well-known material for the production of fabrics and in very widespread use. Cellulose is capable of cross-linking by hydrogen bonds, which form between the cellulose chains.

The majority of garments purchased world-wide contain at least some cellulose fibres in the form of cotton or rayon and these suffer from the well-known problem that on exposure to water, such as during laundering, fibre dimensions change and cause shrinking and wrinkling of the garments. It is believed that this is due to release and reformation of hydrogen bonds.

So-called ‘durable press’ treatments of fabrics are intended to overcome these difficulties. One of the most common methods of durable pressing uses a crosslinking agent to immobilise cellulose at a molecular level. Known cross-linking agents include formaldehyde, and urea-glyoxal resins. Other proposals include epichlorohydrins, vinyl sulphones, triazines, acryloamide and acryloacrylates. None of these proposed technologies have demonstrated real commercial viability to date.

A preferred durable press system should be a non-toxic, have low iron-cure times, have some affinity for the fabric surface and not cause fabric strength losses.

U.S. Pat. No. 6,036,731 (Ciba Speciality Chemicals: 1998) discloses a very general cross-linking material for cellulose, of the structure A-Rₙ, where A is a colourless radical (which can be, amongst others, alkoxy) and R includes at least two fibre reactive groups (which can be, amongst others, a asymmetrical or symmetrical triazine ring).

WO 01/23660 and WO 01/23661 (P&G: 1999) disclose fabric treatment compositions comprising a triazine based fabric modifying compound.

### BRIEF DESCRIPTION OF THE INVENTION

We have determined that excellent cross-linking benefits can be obtained in laundry treatment by use of a triazine-based, cellulose cross-linking agent that has a highly flexible linking group between at least two, mono-reactive cross-linking moieties.

Accordingly, the present invention provides a cellulose cross linking agent, which is not a reactive dye, and which is water soluble or soluble in a water miscible solvent in which the cellulose cross-linking agent comprises two or more mono-reactive s-triazine moieties bridged by a flexible bridging moiety, said bridging moiety comprising at least one aliphatic polyoxyalkylene chain, and wherein each s-triazine moiety is provided with a hydrophilic or a non-hydrophilic substituent group.

A highly preferred form of the cellulose cross-linking agents can be represented by the general structure (1):
(R₁)(X₁)T-L₁-B-L₂-T(X₂)(R₂) (1)
wherein:

R1 and R2 are cellulose-unreactive substituent groups on the s-triazine (T) and may be the same or different,

X1 and X2 are leaving groups on the s-triazine which are lost on reaction with cellulose and may be the same or different,

L1 and L2 are linking groups, and may be the same or different or absent,

B is the bridging group comprising or consisting of at least one aliphatic polyoxyalkylene chain.

It is important that the bridging moiety (B) is flexible and allows relatively free independent movement of the s-triazine groups that it connects. Typically it will be 5-100 atoms in length.

Suitable bridging moieties include: Diethylene glycol, Triethylene glycol, Tetraethylene glycol, Pentaethylene glycol, Hexaethylene glycol, other poly(ethylene glycol), Dipropylene glycol, Tripropylene glycol other poly(propylene glycol), Jeffamine D-230™ (ex. Huntsman), Jeffamine D-400™ (ex. Huntsman), Jeffamine EDR-148™ (Triethylene glycol diamine) (ex. Huntsman), 2,2′-Oxy(bisethylamine) and Tetraethylene glycol amine.

Preferably the bridging moiety is polyethylene glycol or polypropylene glycol or mixed C2/C3 polyglycol. Particularly preferred bridging moieties comprise 2-10, more preferably 2-7, ethylene and/or propylene glycol units.

The bridging group (B) can be joined to the s-triazine through either an oxygen or a nitrogen linkage. Compounds according to the present invention with —HN— linked bridging groups can be derived by reaction of amine terminated polyoxyalkylenes with cyuranic chloride and subsequent reaction with a hydroxy acid. A suitable amine terminated polyoxyalkylene is Jeffamine D-400™ (ex Huntsman). Compounds with —O— linking groups can be prepared by the reaction of polyoxyalkyenes with cyuranic chloride to form the dichloro triazine derivative and subsequent reaction with a —O— linking substituent (such as a hydroxy acid) or —NH— linking substituent such as an amino acid (such as glycine or taurine).

Each s-triazine moiety is preferably a mono-chloro triazine. The chlorine atom is displaced during the reaction (as hydrogen chloride) with cellulose.

Alternative cellulose-reactive leaving groups (X1, X2) to chlorine can be employed. These include other halogen, thioglycolate, citrate, nicotinate, (4-sulphonyl-phenyl) amino, (4-sulphonylphenyl)oxy, and mixtures thereof.

The mono-reactive nature of the s-triazines ensures that only single cross-linking events occur at each triazine group. This significantly reduces loss of integrity of fabric being treated.

Each s-triazine moiety is provided with a hydrophilic or non-hydrophilic substituent (R1, R2), preferably a hydrophilic substituent.

The substituent (R1, R2) may be linked through a heteroatom, preferably a nitrogen, sulfur or an oxygen linkage. Suitable substituent groups include polyethers and quaternerised amine derivatives (for example hydroxy amines). Preferred hydrophilic substituents include hydroxy acids, amino acids, mercaptans and amino-sulphonates, each in their salt forms. Mixtures of these substituent groups can be used. In the alternative, the substituent can be low molecular weight non-hydrophilic moiety, preferably with a chain length of from C1 to C10, more preferably of from C1 to C4 and most preferably of from C1 to C3 (such as a methoxy group or a propyl amine) if the flexible bridging moiety (B) comprises a sufficiently long polyoxyalkylene chain to provide sufficient hydrophilicity.

Particularly preferred hydrophilic substituents include

a) Amino acids. It is preferred that the amino acid is in salt form (for example sodium or potassium salt). Both natural and non-natural amino acids are included, for example:
natural amino acids include: Glycine, Alanine, Valine, Leucine, Isoleucine, Serine, Lysine, Proline, Aspartic Acid, Glutamic Acid, Cysteine, Arginine, Asparagine, Glutamine, Histadine, Methionine, Threonine, Phenyl alanine, Tryptophan, Tyrosine
Non-natural amino acids include: Iminodiacetic acid, 2-Aminobutyric acid, 2-(methylamino) isobutyric acid, 2-Aminobutyric acid, Tert-leucine, Norvaline, Norleucine, 2,3-Diaminopropionic acid, 2-Aminocaprylic acid, β-Alanine, 3-Aminoisobutyric acid, 4-Aminobutyric acid, 5-Aminovaleric acid, Homoserine, 4-Amino-3-hydroxybutyric acid, 5-Aminolevulinic acid, 5-Hydroxy-DL-lysine, 1-Amino-1-cyclopropane carboxylic acid, 2,3-Diaminopropionic acid, DL-2, 4-diaminobutyric acid, Ornithine, 2-Methylglutamic acid, 2-Aminoadipic acid, Penicillamine, Homocysteine, Cystine, Methyl cysteine, Ethionine, and S-Carboxymethyl-L-cysteine

b) Hydroxy acids. It is again preferred that the hydroxy acid is in salt form (for example sodium or potassium salt). Examples of suitable hydroxy acids are:
Glycolic acid, Lactic acid, 2-Hydroxyisobutyric acid, 3-Hydroxybutyric acid, 2-Hydroxy-2-methylbutyric acid, 2-Ethyl-2-hydroxybutyric acid, 2-Hydroxyisocaproic acid, 2-Hydroxycaproic acid, 2,2-Bis(hydroxymethyl)propionic acid, Gluconic acid, Malic acid, Citramalic acid, 2-Isopropylmalic acid, 2-Isopropylmalic acid, 3-Hydroxy-3-methylglutaric acid, Tartaric acid, Mucic acid, and Citric acid

c) Mercaptans. It is again preferred that the mercaptan is in salt form (for example sodium or potassium salt).

Examples of mercaptans include: Mercaptoacetic acid, Thiolactic acid, 3-Mercaptopropionic acid and Mercaptosuccinic acid

d) Sulphonates. It is preferred that the sulphonate is in salt form (for example sodium or potassium salt). Examples of sulphonates include: Formaldehyde sodium bisulfite addition compounds, Isethionic acid, 3-Hydroxy-1-propanesulphonic acid, 2-Mercaptoethanesulphonic acid,3-Mercapto-1-propanesulphonic acid, Aminomethanesulphonic acid, 3-Amino-1-propanesulphonic acid, and, Taurine

e) Quaternerised Amine Derivatives: These include Quaternerised derivatives of the following amines (known quaternerising agents include CH₃I, CH₃Cl, (CH₃)₂SO₄):N,N-Dimethylethanol amine, N,N-Diethylethanol amine, 2-(Diisopropylamino)ethanol, 2-(Dibutylamino)ethanol, 3-Dimethylamino-1-propanol, 3-Diethylamino-1-propanol, 2-Dimethylamino-2-methyl-1-propanol, 2-[2-(Dimethylamino)ethoxy]ethanol, 2-Dimethylaminoethanethiol, 2-Diethylamino-ethanethiol, 1-(2-Aminoethyl)pyrrolidine, 2-(2-Aminoethyl)-1-methylpyrrolidine, 1-Methyl-2-piperidinemethanol

f) Polyethers. Suitable materials include: Ethylene glycol, Diethylene glycol, Triethylene glycol, Tetraethylene glycol, Pentaethylene glycol, Hexaethylene glycol, other poly(ethylene glycol), Propylene glycol, Dipropylene glycol, Tripropylene glycol, other poly(propylene glycol), and/or the mono-alkoxy derivatives of the above polyethers.

g) Simple alcohols such as methanol, ethanol, propanol and the like.

h) Simple alkylamines such as methylamine, ethylamine, propylamine, butylamine and the like

Combinations of the substituent linking atom and the bridging linking atom for a given s-triazine ring which are preferred are NO, OO and ON, with NN being less preferred.

For —O— linked bridging groups, the linkage may be made, for example, through an etheric oxygen in the polyoxyalkylene chain. If the bridging group is to be —NH— linked to the triazine, then linking groups (L1, L2) will be present.

### DETAILED DESCRIPTION OF THE INVENTION

Various preferred and/or optional features of the product and method aspects of the present invention are described in further detail below.

Preferred Cross Linking Agents:

Especially preferred cross-linking agents include molecules of the formula (2a, 2b) below: 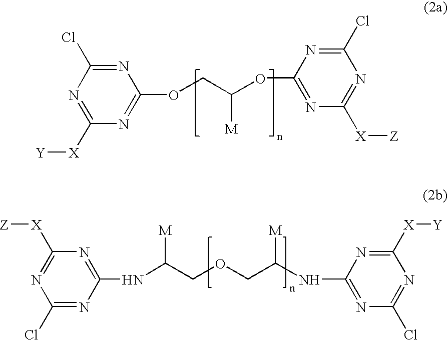
Wherein:

n is 2-10, preferably 2-7

M is independently H or methyl

X is independently S, O or NH

Y and Z are independently cellulose-unreactive substituents.

For compositions in which the cross linker is of type [2a], n is preferably 2-4 and M is H. It is also preferable that X is —NH— and Y and Z are independently selected from the group comprising: —CH₂—CH₂—SO₃⁻, —CH₂—COO⁻, and —CH₂—CH₂—CH₃.

For compositions in which the cross linker is of type [2b], n is 2-10, preferably 2-7 and M is H or methyl. It is also preferable that X is —O— and Y and Z are independently selected from the group comprising —CH₃, —CH₂—COO⁻ and —CH₂—CH₂—CH₃.

Particularly preferred cross-linkers are:

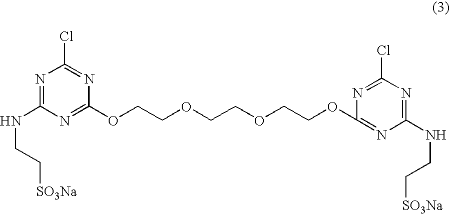

(3) is a taurine Derivative of 1,8-Bis-(4,6-dichloro-[1,3,5]triazin-2-yloxy)-3,6-diox-octane.

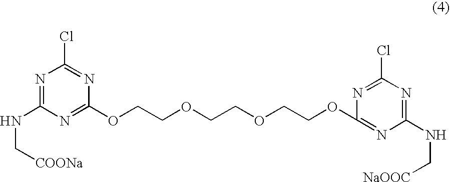

(4) is a glycine Derivative of 1,8-Bis-(4,6-dichloro-[1,3,5]triazin-2-yloxy)-3,6-diox-octane

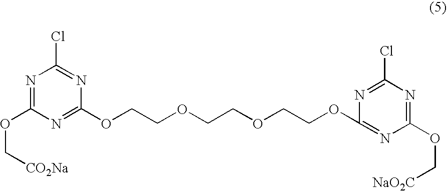

(5) is a glycolic Acid Derivative of 1,8-Bis-(4,6-dichloro-[1,3,5]triazin-2-yloxy)-3,6-diox-octane

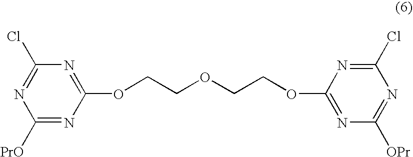

(6) is bis-(2-chloro-4-propoxy-triazine)-6-diethyleneglycol

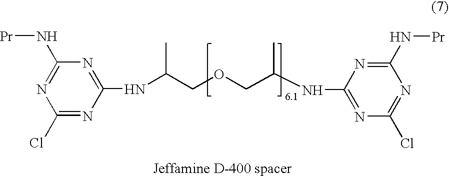

(7) is 2,2′-[D400]Polyoxypropylenediaminobis[4-chloro-6-propylamino-s-triazine]

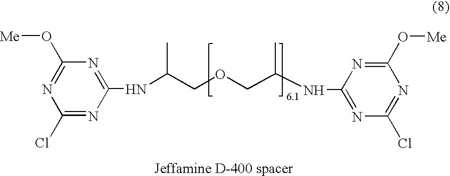

(8) is 2,2′-[D400]Polyoxypropylenediaminobis[4-chloro-6-methoxy-S-triazine]

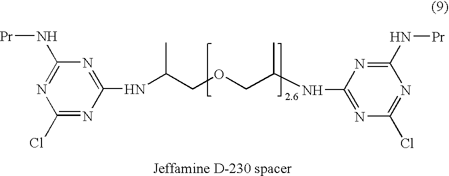

(9) is 2,2′-[D230]Polyoxypropylenediaminobis[4-chloro-6-propylamino-S-triazine].

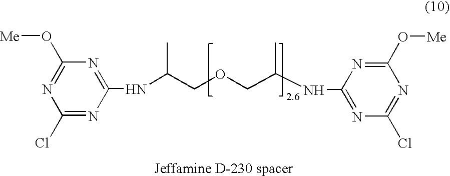

(10) is 2,2′-[D230]Polyoxypropylenediaminobis[4-chloro-6-methoxy-S-triazine]

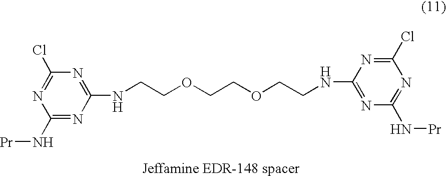

(11) is 2,2′-Triethyleneglycoldiaminobis[4-chloro-6-propylamino-S-triazine]

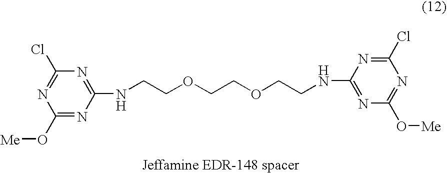

(12) is 2,2′-Triethyleneglycoldiaminobis[4-chloro-6-methoxy-S-triazine.

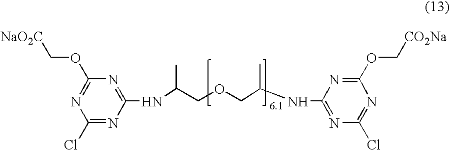

(13) is mono-chloro sodium glycolate triazine derivative of Jeffamine D-400.

The cellulose cross-linking agent of the invention is preferably solid or oil-like.

In order that the invention may be further understood it will be explained hereinafter with reference to illustrative but non-limiting examples.

### EXAMPLES

### Example 1

### Synthesis of 1,8-Bis-(4,6-dichloro-[1,3,5]triazin-2-yloxy)-3,6-diox-octane [E1]

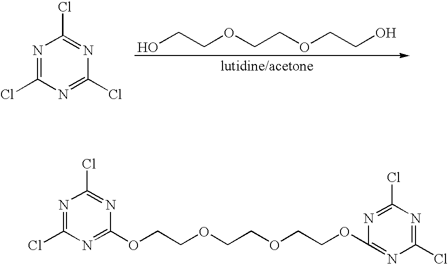

To a solution of cyanuric chloride (20.05 g, 109 mmol) in 140 ml acetone a solution of triethylene glycol (7.77 g, 52 mmol) and 2,6-lutidine (11.25 g, 105 mmol) in 50 ml acetone was added dropwise at 0° C. After addition, the reaction mixture was kept stirring at 0° C. for 2 hr. The resulting mixture was warmed to room temperature overnight, filtrated, and the filtrate was de-coloured with charcoal. After removal of acetone, the residue was purified by column chromatography (eluate: CH₂Cl₂) to give a viscous liquid [E1] (11.3 g, 47%); ¹HNMR (300 MHz, δ, ppm, CDCl₃) 3.68 (s, 4H), 3.86 (t, 4 H), 4.64 (t, 4H); MS-ESI 445 (M+H⁺), 464 (M+NH₄⁺).

### Example 2

### Synthesis of Taurine Derivative of 1,8-Bis-(4,6-dichloro-[1,3,5]triazin-2-yloxy)-3,6-diox-octane [E2]

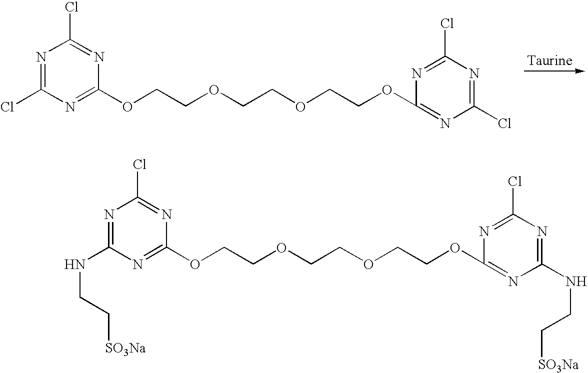

To a 250 ml flask containing 1,8-bis-(4,6-dichloro-[1,3,5]triazin-2-yloxy)-3,6-diox-octane [E1] (7.0 g, 15.7 mmol) and THF (30 ml) was added a solution of taurine (3.9 g, 31.4 mmol) and sodium carbonate (3.33 g, 31.4 mmol) in 60 ml water at 0° C. After addition, the mixture was kept stirring overnight at room temperature. After removal of THF and water, the residue was washed by acetone to give a white solid [E2] (10.6 g, quantity); ¹H NMR (300 MHz, δ, ppm, D₂O) 3.14˜3.2 (m, 4H), 3.75˜3.80 (m, 8H), 3.87˜3.90 (m, 4H), 4.42˜4.53 (m, 4H); MS-ESI 623 (M-2Na⁺+3H⁺), 645 (M−Na⁺+2H⁺), 667 (M+1), 689 (M+Na⁺).

### Example 3

### Synthesis of Glycine Derivative of 1,8-Bis-(4,6-dichloro-[3,5]triazin-2-yloxy)-3,6-diox-octane [E3]

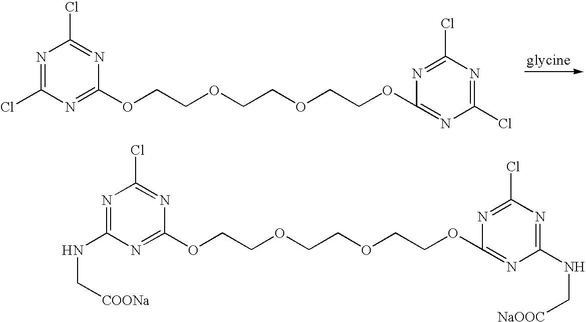

To a 250 ml flask containing 1,8-bis-(4,6-dichloro-[1,3,5]triazin-2-yloxy)-3,6-diox-octane [E1] (8.0 g, 17.9 mmol) and THF (40 ml) was added dropwise a solution of glycine (2.69 g, 35.9 mmol) and sodium carbonate (3.8 g, 35.9 mmol) in 60 ml water at 0° C. After addition, the mixture was kept stirring overnight at room temperature. After removal of THF and water, the residue was washed by acetone to give a slight yellow solid [E3] (10.4 g, quantity); ¹H NMR (300 MHz, δ, ppm, D₂O) 3.74 (s, 4H), 3.84˜3.87 (m, 4H), 3.90 (s, 4H), 4.45˜4.48 (m, 4H); MS-ESI 523 (M-2Na⁺+3H⁺).

### Example 4

### Synthesis of Glycolic Acid Derivative of 1,8-Bis-(4,6-dichloro-[1,3,5]triazin-2-yloxy)-3,6-diox-octane [E4]

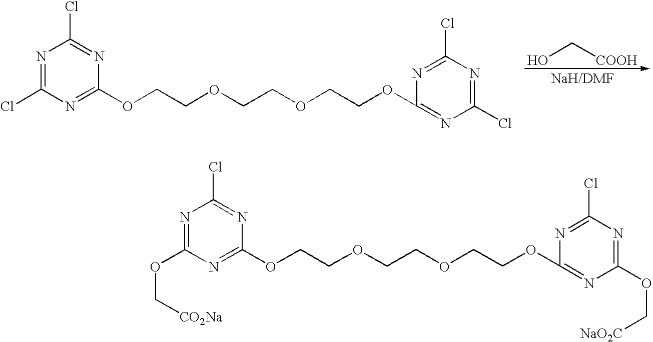

To a 250 ml dry flask containing sodium hydride (2.82 g, 60% in mineral oil, 70.6 mmol) and 30 ml DMF was added dropwise a solution of glycolic acid (2.68 g, 35.3 mmol) in 10 ml DMF at 0° C. After addition, the mixture was kept stirring for 2 hr at room temperature, then cooled by ice bath. 1,8-bis-(4,6-dichloro-[1,3,5]triazin-2-yloxy)-3,6-diox-octane [E1] (7.87 g, 17.65 mmol) in 20 ml DMF was added dropwise. After addition, the reaction mixture was kept stirring at room temperature overnight, then quenched by water. After distilled off the DMF in vacuum, the residue was washed by acetone to give a slight yellow solid [E4] (10.2 g, quantity); ¹H NMR (300 MHz, δ, ppm, DMSO-d₆) 3.54 (s, 4H), 3.64 (t, 4H), 4.20 (t, 4H), 4.91 (s, 4H); MS-ESI 409 (M-2CH₂COONa+3H⁺), 409 (M-2CH₂COONa+2H+Na⁺).

### Example 5

### Synthesis of Bis-(2,4-dichloro-triazine)-6-diethylenegycol [E5]

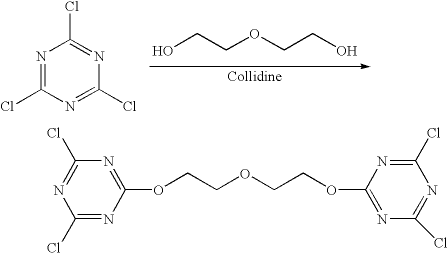

Cyanuric Chloride (21.6 g, 0.117 M) is dissolved in 250 ml of acetone and cooled with stirring in an ice-salt bath under a blanket of N₂. Diethylene glycol (6.2 g, 0.0585 M) and collidine (14.2 g, 0.117 M) in 80 ml of acetone is added slowly dropwise with stirring at a temperature of 0° C. to 5° C. The reaction mixture is stirred at 0 to 5° C. for 2 hours and then allowed to warm to room temperature slowly and left stirring for a further 12 hours (a white precipitate of collidine HCl in a yellow solution is observed). The collidine hydrochloride is filtered off, washed with acetone (150 ml) and the filtrate evaporated to dryness to yield a crude orange solid (fraction 1), 26 g (100%). A sample of the crude product (10 g) is recrystallised from petroleum ether (80-110° C.) to yield a crude yellow solid (fraction 2), 7.5 g (75% yield). A sample of the crude yellow solid, (5.38 g) is decolourised with acetone/charcoal at room temperature to yield the product as a white solid [E5 ], 4.64 g (64.5% yield).

### Example 6

### Synthesis of Bis-(2-chloro-4-propoxy-triazine)-6-diethyleneglycol [E6]

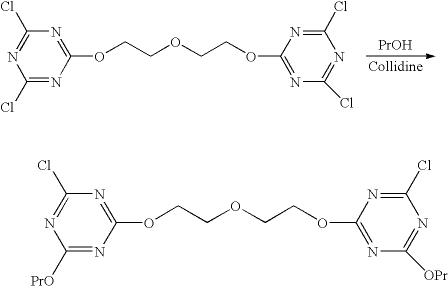

Bis-(2,4-dichloro-triazine)-6-diethyleneglycol [E5] (5 g, 0.0124 M), collidine (3 g, 0.0248 M) and propan-1-ol (1.49 g, 0.0248 M) were placed into a 50 ml round bottom flask fitted with a condenser. The reaction mixture was heated to 1000° C. for 2 hours, cooled and acetone added (40 ml). The resultant white precipitate was filtered off and the dark orange filtrate decolourised twice at room temperature with charcoal. The orange solution was evaporated to dryness to yield an orange oil [E6] (4.87 g, 87% yield).

### Example 7

### Synthesis of 4,6-Dichloro-N-methyl-1,3,5-triazin-2-amine [E7]

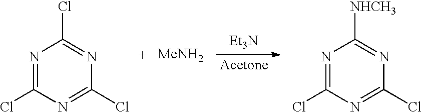

Cyanuric chloride (9.5 g, 0.052 M) was placed into a 3 necked 500 ml round bottom flask fitted with a thermometer, pressure equalising dropping funnel and stirrer bar. Acetone (150 ml) was added and the cyanuric chloride dissolved with stirring at room temperature to give a clear colourless solution followed by cooling in an ice/salt bath to 0° C. To this solution was added a mixture of methylamine (40% soln, 4.65 ml, 0.052M) and triethylamine (5.5 g, 0.052 M) via a dropping funnel over a period of 30 minutes with stirring. The temperature of the reaction mixture was maintained between 0-5° C. during the addition (on addition a turbid yellow reaction mixture was observed). On complete addition the ice bath was removed and stirring continued for a further 3 hours. The reaction mixture was transferred to a rotary evaporator flask and the acetone removed under reduced pressure. The Reaction mixture was dissolved in ethylacetate, washed with dilute HCl to remove triethylamine and further washed with water (2×100 ml), 5% sodium bicarbonate solution (1×50 ml), water (2×100 ml), saturated sodium chloride solution (1×50 ml), dried over magnesium sulphate, filtered and the filtrate evaporated to yield a pale yellow solid [E7] (3.9 g, 50% yield).

### Example 8

### Synthesis of 2,2′-[D40O]Polyoxypropylene-diaminobis [4,6-dichloro-s-triazine] [E8]

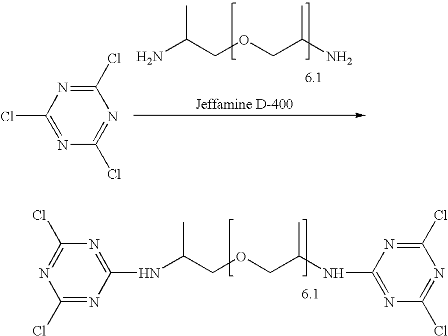

Cyanuric chloride (10.29 g, 0.0558 M) is dissolved in tetrahydrofuran (THF, 120-150 ml) and cooled to −5° C. to 0° C. in an ice/acetone bath. Jeffamine D-400 (11.6 g, 0.0279 M) in 30 ml of water is added slowly dropwise with stirring at a temperature of −5° C. to 0° C. (during addition the reaction mixture has a slightly milky appearance). Sodium hydroxide (2.5 g, 0.0625 M) in 20 ml water is added slowly dropwise with stirring at a temperature of −5° C. to 5° C. (on complete addition the reaction mixture has a milky appearance). The reaction mixture is allowed to warm to room temperature (18-200° C.) with stirring (1 hour). THF is removed under reduced pressure to leave a white oily/water mixture. This is dissolved in chloroform (200 ml) and washed with water (3×100ml), brine (2×50 ml), dried over magnesium sulphate, filtered and evaporated to dryness to yield a clear pale yellow viscous oil [E8] (18.3 g, 94% yield).

### Example 9

### Synthesis of 2,2′-[D400]Polyoxypropylene-diaminobis [4-chloro-6-propylamino-s-triazinel [E9]

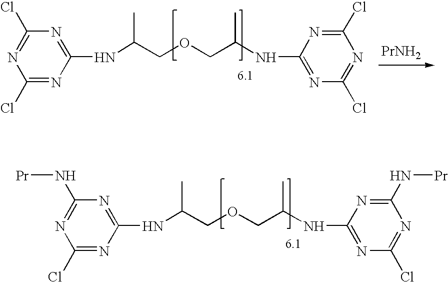

2,2′-[D400]Polyoxypropylenediaminobis [4,6-dichloro-s-triazine] [E8] (2.85 g, 4.1 mM) is dissolved in acetone (75 ml) and warmed to 30-35° C. Propylamine (0.48 g, 8.2 mM) is added directly to give a clear pale yellow reaction mixture. Sodium hydroxide (0.33 g, 8.25 mM) in 5 ml water is added dropwise over 5 min. with stirring (a turbid reaction mixture is observed). The turbid reaction mixture is then stirred at 35° C. for 1 hour followed by a further hour at 60-700° C. Acetone is removed under reduced pressure to yield an oil/water reaction mixture. This is dissolved in dichloromethane (100 ml) and washed with water (3×30 ml), brine (2×20 ml), dried over magnesium sulphate, filtered and evaporated to dryness to yield a clear very pale yellow viscous oil [E9] (2.54 g, 84% yield).

### Example 10

### Synthesis of 2-Methoxy[4,6-dichloro-S-triazine] [E10]

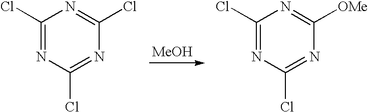

Sodium bicarbonate (33.6 g, 400 mmol) and cyanuric chloride (36.8 g, 200 mmol) were added to a mixture of water (25 ml) and methanol (200 ml). The reaction mixture was stirred vigorously for 30 mins. at 30° C. After which time heating was stopped and water (200 ml) added to the reaction mixture. The precipitate formed was filtered off and washed with water to yield the product [E10] as a white solid (30.3 g, 84%). Purity of the product was good but a small sample was sublimed for analysis.

The structure of the product was confirmed by FAB mass spectroscopy M+H (2 ×Cl isotope pattern). δ_{H} (500 MHz; CDCl₃) ; 4.14 (s, 3H, OCH₃) ; δ_{c} (125 MHz; CDCl₃) 172.61, 171.54, 56.97.

### Example 11

### Synthesis of 2,2′-[D400]Polyoxypropylene-diaminobis [4-chloro-6-methoxy-S-triazine] [E11]

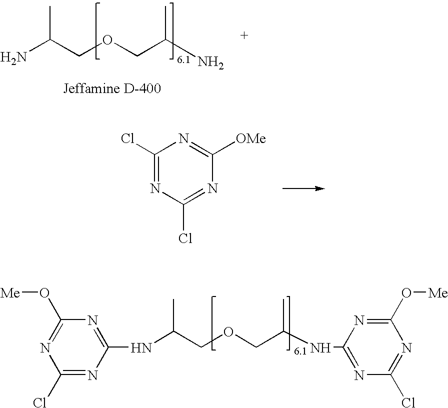

A solution of 2-methoxy[4,6-dichloro-S-triazine] [E10] (5.0 g, 27 mmol) in acetone (150 ml) was added dropwise with stirring to Jeffamine D400 (5.6 g, 13.9 mmol) and sodium hydrogen carbonate (2.32 g, 30 mmol) in acetone (100 ml) and water (250 ml). The reaction mixture was stirred at room temperature for a further 2 hours. The solvents were removed in vacuo and the crude product extracted with chloroform/water. The organic fraction was dried and evaporated to yield the product [E11] as a colourless oil (8.7 g, 91%).

δ_{H} (500 MHz; CDCl₃); 4.3-4.2 (brm, 2H, NHCH(CH₃)CH₂OCH₂), 3.98-3.93 (s, 6H, OCH₃), 3.65-3.35 (brm, 22H, NHCH(CH₃)CH₂OCH₂CH(CH₃), 1.26 (brs, 6H, NHCH(CH₃)CH₂OCH₂), 1.12 (brs, 18H, NHCH(CH₃)CH₂OCH₂CH(CH₃);

### Example 12

### Synthesis of 2,2′-[D230]Polyoxypropylene-diaminobis [4,6-dichloro-S-triazine] [E12]

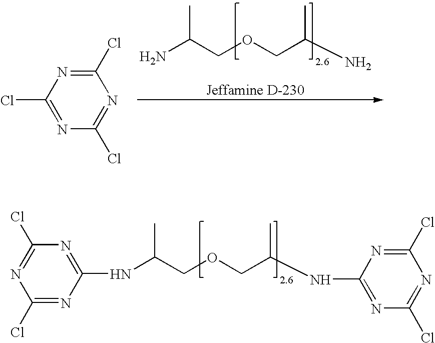

A solution of Jeffamine D230 (23 g, 100 mmol) and sodium hydroxide (8.8 g, 220 mmol) in water (70 ml) was added dropwise with stirring, over two hours at 0° C. to a solution of cyanuric chloride (36.9 g, 200 mmol) in THF (400 ml). The reaction temperature was maintained below 5° C. during the addition. The reaction mixture was then allowed to warm slowly to room temperature and stirred for a further hour. The reaction mixture was evaporated in vacuo. The colourless oil was dissolved in dichloromethane washed and dried (MgSO₄) to yield the product [E12] as a colourless viscous oil (42.1 g, 80%).

δ_{H} (500 MHz; CDCl₃); 4.25 (brm, 2H, NHCH(CH₃)CH₂OCH₂), 3.4-3.6 (brm, 10H, NHCH(CH₃)CH₂OCH₂CH(CH₃), 1.26 (brs, 6H, NHCH(CH₃)CH₂OCH₂), 1.11 (brs, 6H, NHCH(CH₃)CH₂OCH₂CH(CH₃);

### Example 13

### Synthesis of 2,2′-[D230]Polyoxypropylene-diaminobis [4-chloro-6-propylamino-S-triazine] [E13]

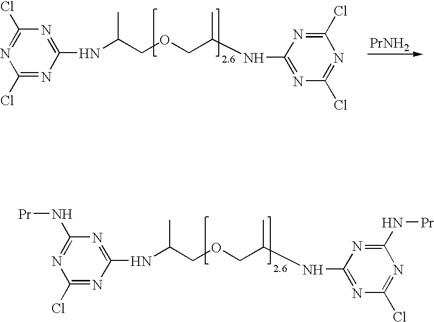

A solution of bis(triazine) [E12] (9.21 g, 17.5 mmol) in acetone (75 ml) was added to a vigorously stirred solution of propylamine (2.06 g, 35 mmol) and sodium hydroxide (1.4 g, 35 mmol) in water (10 ml) and acetone (75 ml). The reaction mixture was heated to 45° C. for 1 hour. The solvents were removed by rotary evaporation to yield a yellow oil. This was dissolved in dichloromethane washed with water and dried (MgSO₄). After evaporation the product [E13] was obtained as a pale yellow oil (4.8 g, 91%).

δ_{H} (500 MHz; CDCl₃); 4.25 (brm, 2H, NHCH(CH₃)CH₂OCH₂), 3.3-3.7 (brm, 12H, NHCH(CH₃)CH₂OCH₂CH(CH₃) plus NHCH₂CH₂CH₃), 1.55 (br, 4H, NHCH₂CH₂CH₃), 1.20 (brs, 6H, NHCH(CH₃)CH₂OCH₂), 1.13 (brs, 6H, NHCH(CH₃)CH₂OCH₂CH(CH₃), 0.92 (br, 6H, NHCH₂CH₂CH₃);

### Example 14

### Synthesis of 2,2′-[D230]Polyoxypropylene-diaminobis [4-chloro-6-methoxy-S-triazine] [E14]

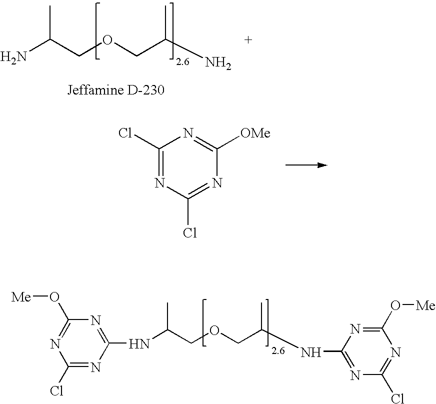

Jeffamine D230 (3.19 g, 13.9 mmol) in dioxane (40 ml) and water (10 ml) was added dropwise with stirring to 2-methoxy [4,6-dichloro-S-triazine] [E10] (5.0 g, 28 mmol) and sodium carbonate (1.6 g, 30 mmol) in dioxane (50 ml) to The reaction mixture was heated to 75° C. for a further 2 hours and cooled overnight. The solvents were removed in vacuo and the crude product extracted with chloroform/water. The organic fraction was dried and evaporated to yield the product [E14] as a pale yellow oil (7.1 g, 70%).

δ_{H} (500 MHz; CDCl₃); 4.4-4.2 (brm, 2H, NHCH(CH₃)CH₂OCH₂), 3.9 (s, 6H, OCH₃), 3.7-3.3 (brm, 10H, NHCH(CH₃) CH₂OCH₂CH(CH₃), 1.25 (brs, 6H, NHCH(CH₃)CH₂OCH₂), 1.10 (brs, 6H, NHCH(CH₃) CH₂OCH₂CH(CH₃);

### Example 15

### Synthesis of 2,2′-Triethyleneglycoldiamino-bis [4,6-dichloro-S-triazine] (Jeffamine EDR-148) [E15]

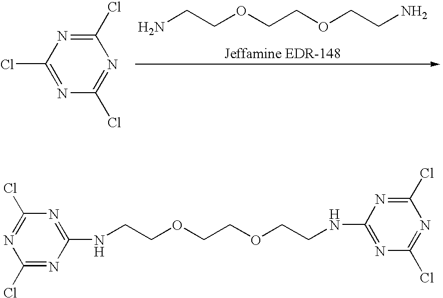

A solution of Jeffamine EDR148 (16.05 g, 110 mmol) and sodium hydroxide (9.5 g, 230 mmol) in water (70 ml) was added dropwise with stirring, over two hours at 0° C. to a solution of cyanuric chloride (40.0 g, 220 mmol) in THF (400 ml). The reaction temperature was maintained below 5° C. during the addition. The reaction mixture was then allowed to warm slowly to room temperature and stirred for a further hour. The reaction mixture was filtered and the filtrate evaporated to give a white solid. This was washed with acetone and water to yield the product [E15] (40 g, 83%).

δ_{H} (500 MHz; CDCl₃); 9.1 (t, 2H, NH), 3.53 (m, 8H, NCH₂CH₂OCH₂) 3.45 (m, 4H, NCH₂CH₂OCH₂); □_{c} (125 MHz; CDCl₃) 170.0,169.0, 164.7, 69.5, 68.1, 40.2;

### Example 16

### Synthesis of 2,2′-Triethyleneglycoldiamino-bis [4-chloro-6-propylamino-S-triazine] [E16]

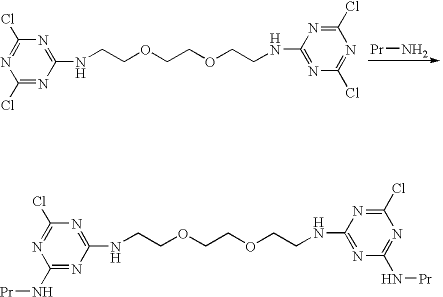

Bis(triazine [E15] (10.0 g, 23 mmol) was added to a vigorously stirred solution of propylamine (2.7 g, 45 mmol) and sodium bicarbonate (3.8 g, 48 mmol) in water (40 ml) and acetone (125 ml). The reaction mixture was heated to 45° C. for 1 hour. After cooling, the solvents were removed by rotary evaporation to give a white solid. This washed with water to yield the product [E16] (10.2 g, 93%).

δ_{H} (500 MHz; CDCl₃); 4.25 (brm, 2H, NHCH(CH₃)CH₂OCH₂), 3.3-3.7 (brm, 12H, NHCH(CH₃)CH₂OCH₂CH(CH₃) plus NHCH₂CH₂CH₃), 1.55 (br, 4H, NHCH₂CH₂CH₃), 1.20 (brs, 6H, NHCH(CH₃)CH₂OCH₂), 1.13 (brs, 6H, NHCH(CH₃)CH₂OCH₂CH(CH₃), 0.92 (br, 6H, NHCH₂CH₂CH₃);

### Example 17

### Synthesis of 2,2′-Triethyleneglycoldiamino-bis [4-chloro-6-methoxy-S-triazine [E17]

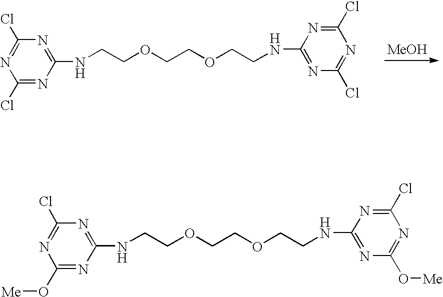

A solution of 2-methoxy[4,6-dichloro-S-triazine] [E10] (5.0 g, 28 mmol) in acetone (150 ml) was added dropwise with stirring to Jeffamine EDR148 (2.06 g, 14 mmol) and sodium carbonate (1.64 g, 16 mmol) in dioxane (100 ml) and water (250 ml). The reaction mixture was heated to 75° C. for a further 2 hours and cooled overnight. The solvents were removed in vacuo and the crude product extracted with chloroform/water. The organic fraction was dried and evaporated to yield the product [E17] as a white solid (8.1 g, 84%).

δ_{H} (500 MHz; CDCl₃); 3.9 (s, 6H OCH₃), 3.66-3.62 (m, 12H, NCH₂CH₂OCH₂);

### Example 18

### Synthesis of Ethyl [(4,6-dichloro-1,3,5-triazin-2-yl)oxy]acetate [E18]

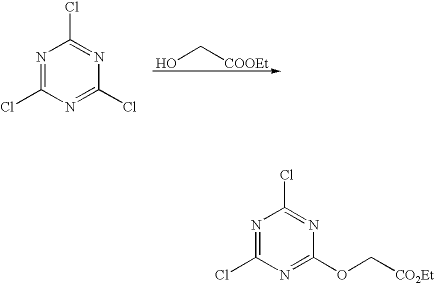

To a 250 ml flask containing cyanuric chloride (9.23 g, 50 mmol) in 100 ml acetone, a solution of ethyl glycolate (4.0 g, 38.46 mmol) and 2,6-lutidine (5.35 g, 50 mmol) in 30 ml acetone was added dropwise at 0° C. After addition, the reaction mixture was kept stirring at 0° C. for 2 hr. Then the mixture was warmed to r. t. overnight, filtrated, and the filtrate was discoloured with charcoal. After removal of acetone, the residue was purified by column chromatography (eluate: hexane/dichloromethane=4/1) to give a viscous liquid [E18] (7.73 g, 79.9%); ¹H NMR (400 MHz, δ, ppm, CDCl₃) 1.29 (t, 3H), 4.28 (q, 2 H), 4.50 (s, 2H); MS-ESI 252 (M+H⁺), 274 (M+Na⁺).

### Example 19

### Mono-chloro ethyl glycolate triazine derivative of Jeffamine D-400 [E19]

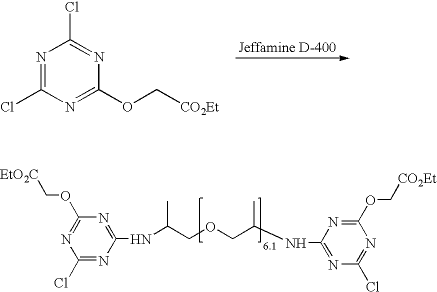

To a 250 ml flask containing ethyl [(4,6-dichloro-1,3,5-triazin-2-yl)oxy]acetate [E18] (7.73 g, 30.7 mmol) in 50 ml THF and sodium carbonate (1.63 g, 15.3 mmol) in 30 ml water, a solution of Jeffamine D-400 (6.14 g, 15.3 mmol) in 30 ml THF was added dropwise at 0° C. After addition, the reaction mixture was kept stirring overnight at r.t. After removal of THF, the water solution was extracted with dichloromethane (2×70 ml), and the organic phase was washed with brine, dried over sodium sulfate. After removal of the solvent, a slight yellow liquid was obtained [E19] (12.5 g, 98%): ¹H NMR (400 MHz, δ, ppm, CDCl₃) 1.10˜1.30 (m, 30H), 3.46˜3.61 (m, 24 H), 4.22˜4.27 (m, 4H), 4.84˜4.94 (m, 4 H) ; MS-ESI 677+58n (M+H⁺) (n=0˜7).

### Example 20

### Mono-chloro sodium glycolate triazine derivative of Jeffamine D-400 [E20]

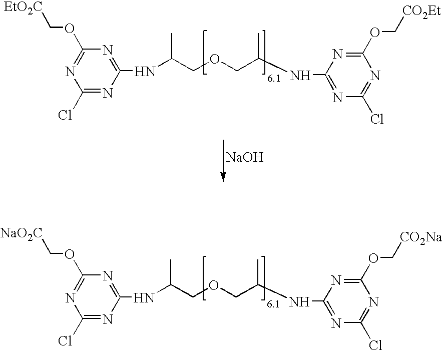

To a 250 ml flask containing mono-chloro ethyl glycolate triazine derivative of Jeffamine [E19] (12.5 g, 15.0 mmol) in 70 ml DMF, was added dropwise a solution of sodium hydroxide (1.22 g, 30.5 mmol) at r.t., after addition, the reaction mixture was kept stirring overnight. After removal of water and DMF in vacuum, the residue was washed with acetone and hexane to give a white solid [E20] (9.3 g, 75.6%): ¹H NMR (400 MHz, δ, ppm, DMSO-d₆) 1.00˜1.07 (m, 24H), 3.29˜3.52 (m, 27 H), 3.86˜4.12 (m, 2H), 4.35˜4.36 (m, 4 H), 8.12˜8.23 (m, 2 H); MS-ESI 689+58n (M+Na⁺) (n=0˜7).

1. A cellulose cross-linking agent, which is not a reactive dye, and which is water soluble or soluble in a water miscible solvent, which comprises two or more mono-reactive s-triazine moieties bridged by a flexible bridging moiety, said bridging moiety comprising at least one aliphatic polyoxyalkylene chain, and wherein each s-triazine moiety is provided with a hydrophilic or a non-hydrophilic substituent group.

2. A composition according to claim 1 wherein the hydrophilic substituent group is selected from the group consisting of hydroxy acids, amino acids, mercaptans and amino-sulphonates or mixtures thereof, each in their salt forms.

3. A composition according to claim 1 wherein the non-hydrophilic substituent group has a chain length of from C1 to C10.

4. A composition according to claim 1 wherein the cellulose cross-linking agent is represented by the general structure (1):
(R₁)(X₁)T-L₁-B-L₂-T(X₂)(R₂) (1)
wherein:
R1 and R2 are cellulose-unreactive substituent groups on s-triazine (T) and may be the same or different,
X1 and X2 are leaving groups on s-triazine (T) which are lost on reaction with cellulose and may be the same or different,
L1 and L2 are linking groups, and may be the same or different or absent,
B is a bridging group comprising or consisting of at least one aliphatic polyoxyalkylene chain.

5. A composition according to claim 4 wherein the bridging group B is 5-100 atoms in length.

6. A composition according to claim 4 wherein the cellulose cross-linking agent is of the formula: 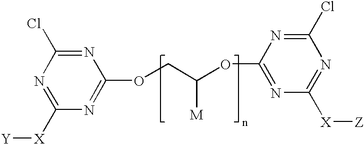
Wherein:
n is 2-10, preferably 2-7
M is independently H or methyl
X is independently S, O or NH
Y and Z are independently cellulose-unreactive substituents.

7. A composition according to claim 6 wherein n is 2-4 and M is H.

8. A composition according to claim 6 wherein X is —NH— and Y and Z are independently selected from the group comprising:
—CH₂—CH₂—SO₃⁻,
—CH₂—COO⁻,
—CH₂—CH₂—CH₃,

9. A composition according to claim 6 wherein the cellulose cross-linking agent is selected from:

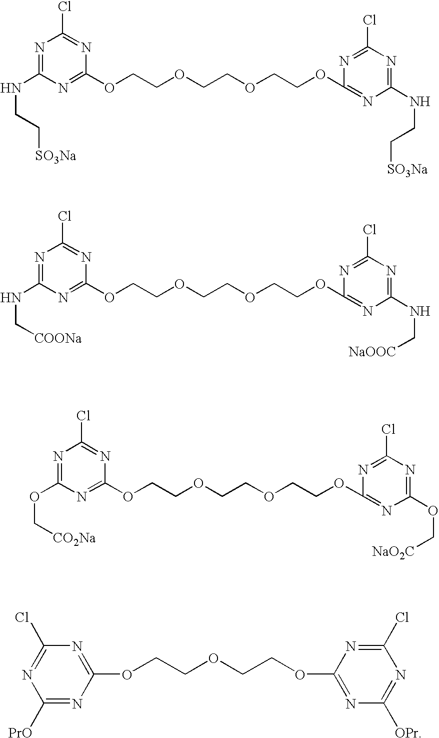

10. A composition according to claim 4 wherein the cellulose cross-linking agent is of the formula: 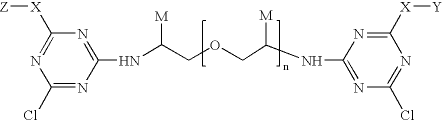
Wherein:
n is 2-10, preferably 2-7
M is independently H or methyl
X is independently S, O or NH
Y and Z are independently cellulose-unreactive substituents.

11. A composition according to claim 10 wherein n is 2-7 and M is H or methyl.

12. A composition according to claim 10 wherein X is —O— and Y and Z are independently selected from the group comprising:
—CH₃,
—CH₂—COO⁻,
—CH₂—CH₂—CH₃,

13. A composition according to claim 10 wherein the cellulose cross linking agents is selected from: [chemical structure]
